(19) United States
(12) Patent Application Publication
(10) Pub. No.: US 2014/0116630 A1
(43) Pub. Date: May 1, 2014

(54) Window-blind

(71) Applicant: Juan Zhou, Zhuhai City (CN)

(72) Inventor: Juan Zhou, Zhuhai City (CN)

(21) Appl. No.: 14/153,100

(22) Filed: Jan. 13, 2014

(30) Foreign Application Priority Data
Nov. 20, 2013 (CN) 201320738770.7

(51) Int. Cl. E06B 9/303

(52) U.S. Cl. CPC E06B 9/303
USPC 160/166.1

(57) ABSTRACT

A window-blind includes at least two ladder ropes extended from a top rail to a bottom rail in vertical direction, and each ladder rope containing parallel first and second banded parts, and ladder strings in horizontal direction placed between the first banded part and the second banded part and distributed equidistantly, and each end of the ladder strings is connected with the first banded part and the second banded part respectively; multiple slats located between the first banded part and the second banded part, and placed successively on the ladder strings from top to bottom; the first banded part having the first side facing the slats and the second side back to the slats, and the first side of the first banded part forming the channel for the pulling cord to pass through; and the pulling cord and the part of the pulling cord pass through the channel.

### BACKGROUND OF THE INVENTION

1. Field of the Invention

The invention relates to window-blind, and particularly relates to a kind of safe window-blind.

2. Description of Related Art

Window-blind actualized the unique status in the market nowadays because its particular modeling and practicability. Whereas, the pulling cord of the present window-blind structure contains underlying unsafe factor, that is, the cord is easily pulled out under the condition of the opening state of the window-blind, thus resulting in the existence of potential safety hazard.

Thus, the need for improvement still exists.

### SUMMARY OF THE INVENTION

The aim of the invention is to provide a kind of window-blind, and in the window-blind structure, the cord located in the blinds can be covered or hidden, so as to eliminate or reduce the potential safety hazard existing in the present window-blind.

The window-blind of invention comprises a top rail and a bottom rail, at least two ladder ropes, the ladder ropes extended from the top rail to the bottom rail. Each ladder rope contains the first banded part and the second banded part in vertical direction paralleled with each other and the ladder strings in horizontal direction which are placed between the first banded part and the second banded part are distributed equidistantly. Each end of the ladder string is connected with the first banded part and the second banded part respectively.

The window-blind of invention further comprises multiple slats, located between the first banded part and the second banded part, and placed successively on the ladder strings from top to bottom.

The first banded part has the first lateral side facing the slats and the second lateral side back to the slats, and the first lateral side of the first banded part forms the channel for the pulling cord to pass through wherein the pulling cord, part of the cord passes through the channel.

In the window-blind of the invention, the first banded part is fabric, and the channel is integrated with the first banded part.

In the window-blind of the invention, the third banded part is fixed on the first lateral side of the first banded part, and the channel is formed between the first banded part and the third banded part, the width of the third banded part is equal to or less than the width of the first banded part.

In the window-blind of the invention, multiple strip parts extending horizontally are set on the first lateral side of the first banded part from top to bottom, and the channel is formed between the strip part and the first banded part.

In the window-blind of the invention, the strip parts are distributed evenly on the first lateral side from top to bottom.

In the window-blind of the invention, the two ends of the slat are placed on the ladder string respectively, and each end of the slat has the cut notch facing the first banded part and the second banded part respectively, and the width of the notch is equal to or greater than the width of the first banded part and the second banded part.

In the window-blind of the invention, the lower end of the pulling cord is fixed and connected with the bottom rail, and the upper end of the cord is placed inside the top rail or passed through the top rail and extended from one side of the top rail.

In the window-blind of the invention, the channel for the pulling cord to pass through is formed on the lateral side facing the slats of the second banded part.

In the window-blind of the invention, the first banded part and/or the second banded part are/is hollow structure, multiple hollow parts are set on the first banded part and/or the second banded part.

In the window-blind of the invention, the ladder string includes two lateral strips paralleling with each other.

The implementation of the window-blind of the invention has the following advantages: in the window-blind of the invention, as the pulling cord is located inside the channel of the first lateral side of the first banded part of the ladder rope, the pulling cord located inside the blind is not easily pulled out, thus reducing or eliminating the potential safety hazard existing in the present window-blind.

The above and other objects, features and advantages of the invention will become apparent from the following detailed description taken with the accompanying drawings.

### BRIEF DESCRIPTION OF THE DRAWINGS

FIG. 1 is the schematic diagram of the window-blind of the invention;

FIG. 2 is the schematic diagram of partial structure in the window-blind of the invention;

FIG. 3 is the schematic diagram of the first kind of structure for the first banded part of the ladder rope in the window-blind of the invention;

FIG. 4 is the schematic diagram of the second kind of structure for the first banded part of the ladder rope in the window-blind of the invention;

FIG. 5 is the schematic diagram of the structure for the slat of the window-blind of the invention;

FIG. 6 is the schematic diagram of the third kind of structure for the first banded part of the ladder rope in the window-blind of the invention; and

FIG. 7 is the schematic diagram of the fourth kind of structure for the first banded part of the ladder rope in the window-blind of the invention.

### DETAILED DESCRIPTION OF THE INVENTION

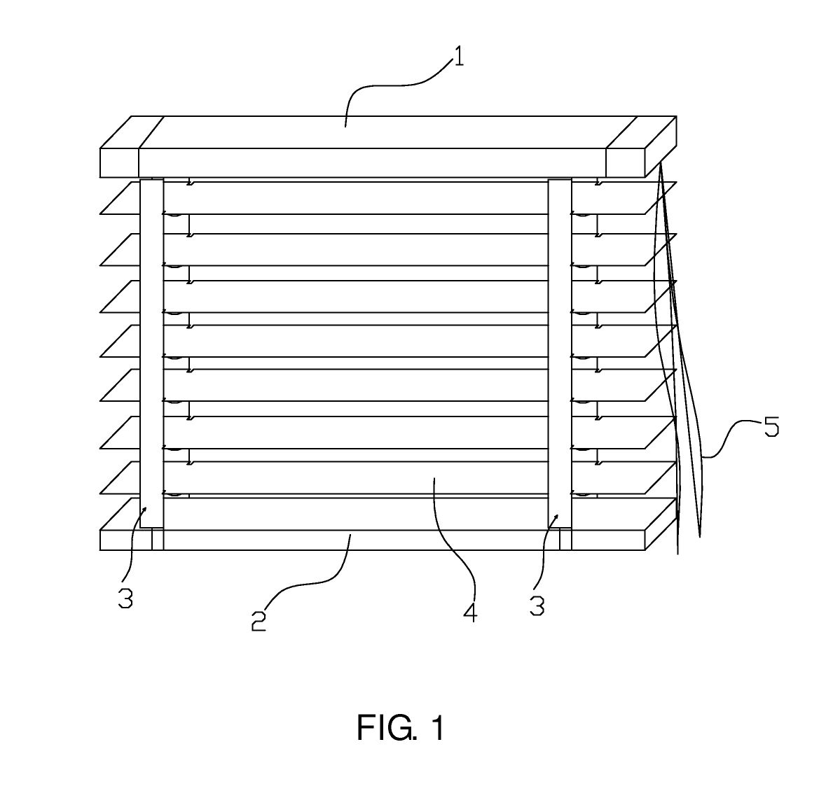

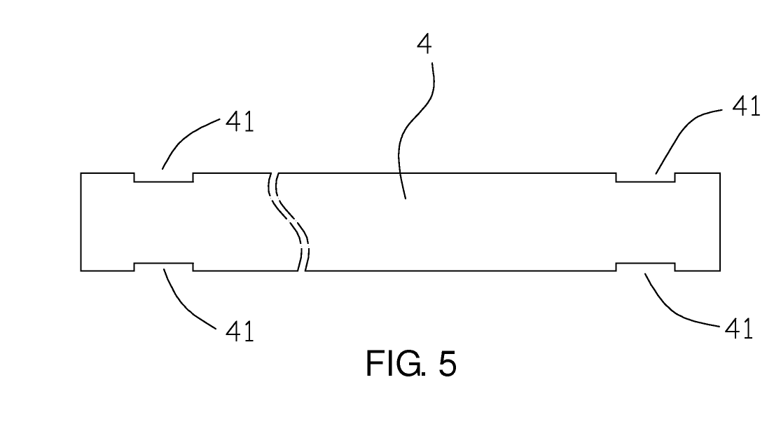

Referring to FIGS. 1 to 7, a window-blind in accordance with the invention is shown.

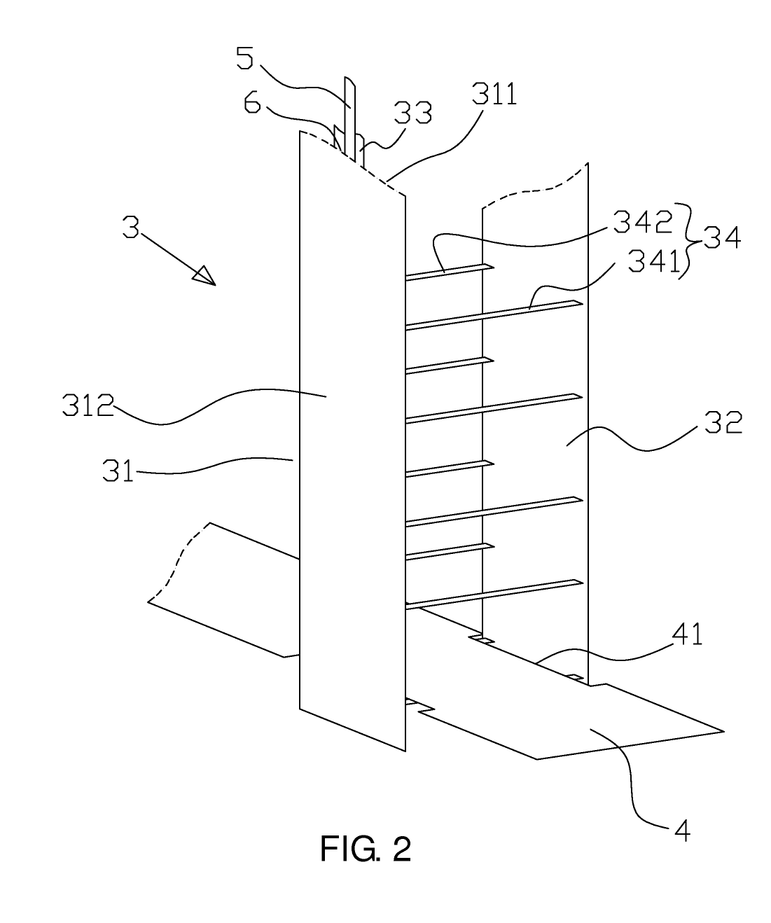

As shown in FIGS. 1 and 2, they are the schematic diagrams of the first example of the window-blind of the invention. The window-blind in the example includes the top rail 1 and the bottom rail 2, the bottom rail 2 is placed under the top rail 1. Two ladder ropes 3 are set between the top rail 1 and the bottom rail 2, and the two ladder ropes 3 are parallel to each other, the ladder ropes 3 extended from the top rail 1 to the bottom rail 2, and each ladder rope 3 contains the first banded part 31 and the second banded part 32 parallel to each other, the first banded part 31 and the second banded part 32 are set one behind the other, and the ladder rope 3 further contains the ladder strings 34 which are placed between the first banded part 31 and the second banded part 32 and distributed equidistantly, and the two ends of the ladder strings 34 are connected with the first banded part 31 and the second banded part 32 respectively, and the ladder strings 34 are used to place the slats 4.

The window-blind of the invention also includes multiple slats which located between the top rail 1 and the bottom rail 2, and located between the first banded part 31 and the second banded part 32, and placed successively on the ladder strings 34 from top to bottom.

The first banded part 31 of the ladder rope 3 of the window-blind in the example has the first lateral side 311 facing the slats 4 and the second lateral side 312 back to the slats 4, in order to prevent the pulling cord 5 inside the slats 4 being pulled out, the channel 6 for the pulling cord 5 to pass through is formed on the first lateral side 311 of the first banded part 31, and the part of the pulling cord 5 passes through the channel 6, and the pulling cord 5 can be moved inside the channel 6, the lower end of the pulling cord 5 is fixed and connected with the bottom rail 2, the upper end of the pulling cord 5 passes through the top rail 1 and extends out from one side of the top rail 1.

The slats 4 of the window-blind can be moved up and down by pulling or releasing the pulling cord 5. For instance, when pulling the pulling cord 5, the pulling cord 5 moves inside the channel 6, the first banded part 31 and the second banded part 32 of the ladder rope 3 are folded separately, multiple slats 4 are folded together, thus the window-blind is moved up. The operation of laying down the window-blind is contrary to the operation of moving up the window-blind.

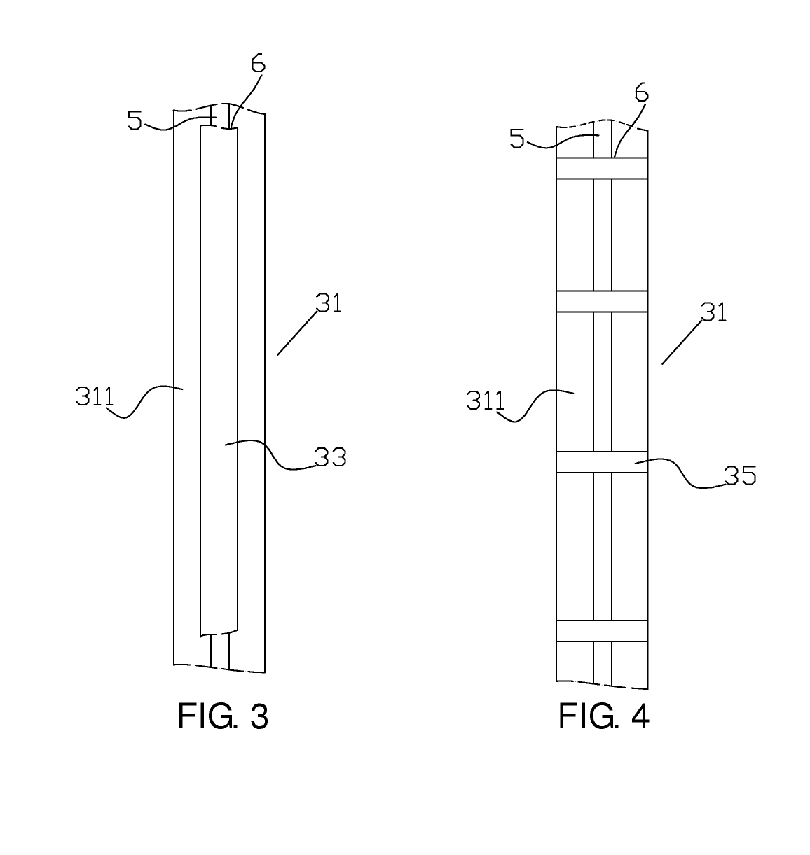

As shown in FIGS. 2 and 3, the third banded part 33 is fixed on the first lateral side 311 of the first banded part 31, and the channel 6 is formed between the first banded part 31 and the third banded part 33, the width of the third banded part 33 is equal to or less than the width of the first banded part 31. The first banded part 31, the second banded part 32 and the third banded part 33 can all be fabrics, such as cotton, linen, chemical fiber, nylon, all kinds of synthetic fibers etc., and forms flexible strips, thus can be folded easily. The third banded part 33 can be connected to the first lateral side 311 of the first banded part 31 by the way of sewing, and the channel 6 is formed between the third banded part 33 and the first banded part 31, the length of the channel 6 is less than or equal to the distance between the top rail 1 and the bottom rail 2.

Besides the above-mentioned structures, the channel 6 can also be formed directly on the first lateral side 311 of the first banded part 31 during the process of weaving, and it can be totally actualized by the present texture technology, the first banded part 31 and the third banded part 33 can be integrated by the way of weaving. In the window-blind of the invention, the first banded part 31 and the third banded part 33 can be dense fabric strips, and also can be sparse reticular structure strips.

As shown in FIG. 4, it is the second kind of structure of the first banded part 31 of the ladder rope 3 for the window-blind of the invention. The major difference from the first structure is that multiple strip parts 35 extending horizontally are set on the first lateral side 311 of the first banded part 31 form top to bottom, and strip parts 35 are distributed evenly on the first lateral side 311, and the channel 6 is formed between the strip parts 35 and the first banded part 31. The advantage of this kind of structure is that the folding of the first banded part 31 is much easier so as to move slats up and down more conveniently, comparing to the first structure of the first banded part 31. The strip part 35 can be connected to the first lateral side 311 of the first banded part 31 by the way of sewing, and can be formed directly on the first lateral side 311 of the first banded part 31 during the process of weaving, and it can be totally actualized by the present texture technology. The above-mentioned strip part 35 and the first banded part 31 can be integrated by the way of weaving.

As shown in FIGS. 1, 2, and 5, in the window-blind of the invention, the two ends of the slat 4 are placed on the ladder string 34 respectively, and the ladder string 34 includes two lateral strips 341/342 paralleled with each other. And the each end of the slat has the notch 41 facing the first banded part 31 and the second banded part 32 respectively, and the width of the notch 41 is equal to or greater than the width of the first banded part 31 and the second banded part 32. And these notches 41 can play the role of positioning, for fixing the position of the slats 4 on the ladder rope 3. In the window-blind of the invention, as the pulling cord is not passed through the slats 4, the slats 4 can be pulled out between the first banded part 31 and the second banded part 32 easily, and it is very convenient for the maintenance of the window-blind. When damages happened in certain slat 4, it is only need to pull out the slat and insert the new one. It is impossible to actualize this convenient maintenance for the present window-blind in which the pulling cord passing through the slats.

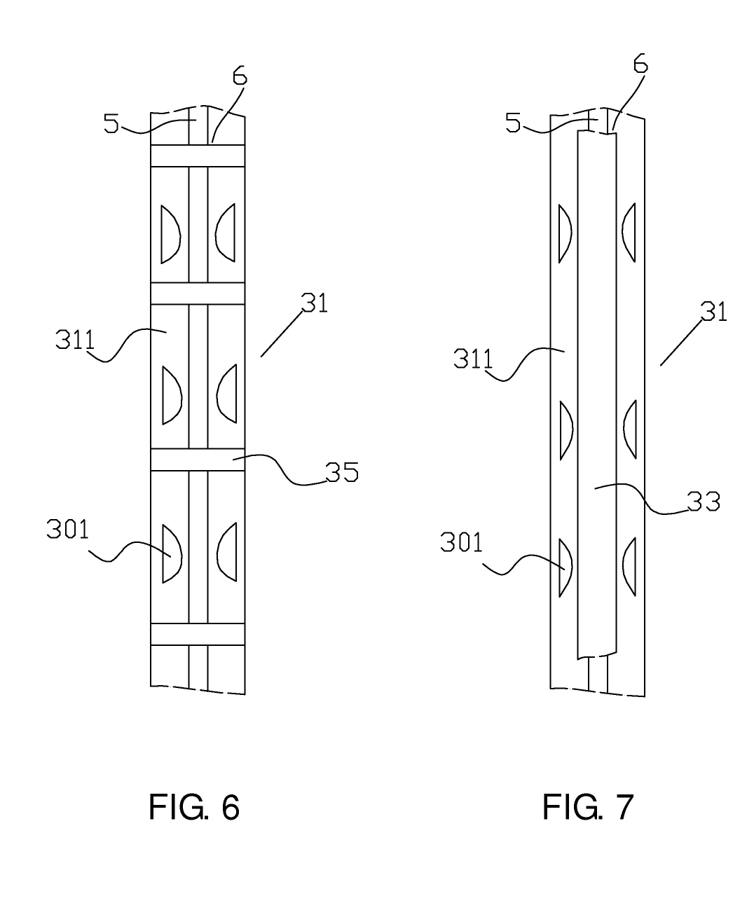

As shown in FIGS. 6 and 7, in order to fold the first banded part 31 and the second banded part 32 of the ladder rope 3 conveniently, the first banded part 31 and the second banded part 32 can be designed to hollow structure, and multiple hollow parts 301 are set on the first banded part 31 and/or the second banded part 32, and the hollow parts 301 can be designed to all kinds of styles, thus beautiful and practical.

In the window-blind of the invention, besides the channel 6 formed on the first lateral side 311 of the first banded part 31, the channel 6 also can be formed on the lateral side facing the slat 4 of the second banded part 32 for the pulling cord 5 to pass through, and the channels 6 are formed both on the first banded part 31 and the second banded part 32, and the pulling cords 5 are set inside both the first banded part 31 and the second banded part 32.

In the window-blind of the invention, the upper end of the pulling cord 5 also can be designed as not extending from the top rail 1 or expose outside of top rail 1, the pulling cord 5 can be placed inside the top rail 1.

In the window-blind of the invention, the quantity of the ladder rope is not limited to the two above-mentioned examples, the quantity of the ladder rope can be more than two, especially when the length of the slats of the window-blind is longer.

In the window-blind of the invention, as the pulling cord is placed inside the channel of the first lateral side of the first banded part of the ladder rope, the part of the pulling cord inside the blinds can not be pulled out easily, thus reducing or eliminating the potential safety hazard existing in the present window-blind.

While the invention has been described in terms of preferred embodiments, those skilled in the art will recognize that the invention can be practiced with modifications within the spirit and scope of the appended claims.

What is claimed is:

1. A window-blind, comprising:
a top rail (1) and a bottom rail (2);
at least two ladder ropes (3), the ladder ropes (3) extended from the top rail (1) to the bottom rail (2), and each of the ladder ropes (3) including a first banded part (31) and a second banded part (32) parallel to the first banded part (31) in vertical direction, and ladder strings (34) in horizontal direction placed between the first banded part (31) and the second banded part (32) and distributed equidistantly wherein each end of each of the ladder strings (34) is connected with the first banded part (31) and the second banded part (32) respectively; and
a plurality of slats (4) located between the first banded part (31) and the second banded part (32), and placed successively on the ladder strings (34) from top to bottom;
wherein the first banded part (31) has a first lateral side (311) facing the slats (4) and the second lateral side (312) back to the slats (4); the first lateral side (311) of the first banded part (31) forms a channel (6) for the pulling cord (5) to pass through; and the pulling cord (5) and the part of the pulling cord (5) pass through the channel (6).

2. The window-blind of the claim 1, wherein the first banded part (31) is fabric, and the channel (6) is integrated with the first banded part (31).

3. The window-blind of the claim 1, wherein the third banded part (33) is fixed on the first lateral side (311) of the first banded part (31), and the channel (6) is formed between the first banded part (31) and the third banded part (33), the width of the third banded part (33) is equal to or less than the width of the first banded part (31).

4. The window-blind of the claim 1, further comprising a plurality of strip parts (35) extending horizontally on the first lateral side (311) of the first banded part (31) from top to bottom, and wherein the channel (6) is formed between the strip parts (35) and the first banded part (31).

5. The window-blind of the claim 4, wherein the strip parts (35) are distributed evenly on the first lateral side (311) from top to bottom.

6. The window-blind of the claim 1, wherein two ends of each of the slats (4) are placed on the ladder string (34) respectively, the each end of slats (4) has a notch (41) facing the first banded part (31) and the second banded part (32) respectively, and the width of the notch (41) is equal to or greater than the width of the first banded part (31) and the second banded part (32).

7. The window-blind of the claim 1, wherein the lower end of the pulling cord (5) is securely connected with the bottom rail (2), and the upper end of the pulling cord (5) is placed inside the top rail (1) or passed through the top rail (1) and extended from one side of the top rail (1).

8. The window-blind of the claim 1, wherein the channel (6) for the pulling cord (5) to pass through is formed on a lateral side facing the slats (4) of the second banded part (32).

9. The window-blind of the claim 1, wherein the first banded part (31) and/or the second banded part (32) are/is hollow structure, and further comprising a plurality of hollow parts (301) set on the first banded part (31) and/or the second banded part (32).

10. The window-blind of the claim 1, wherein the ladder string (34) includes two lateral strips (341, 342) parallel to each other.
